(19) United States
(12) Patent Application Publication
(10) Pub. No.: US 2019/0017597 A1
(43) Pub. Date: Jan. 17, 2019

(54) Control Methods For Heat Recovery In A Ball-Type Continuously Variable Transmission

(71) Applicant: Dana Limited, Maumee, OH (US)

(72) Inventor: Jeffrey M. David, Cedar Park, TX (US)

(21) Appl. No.: 16/031,583

(22) Filed: Jul. 10, 2018

Related U.S. Application Data
(60) Provisional application No. 62/531,076, filed on Jul. 11, 2017.

(51) Int. Cl. F16H 61/664; F16H 57/04; F16H 15/50

(52) U.S. Cl. CPC F16H 61/664; F16H 57/0412; F16H 2200/20; F16H 2300/02; F16H 15/503

(57) ABSTRACT

Provided herein is a vehicle including: an engine; a continuously variable planetary (CVP) operably coupled to the engine; a cooling system in fluid communication with the engine and the CVP, the cooling system comprising a control valve and a working fluid; and a control system including a controller configured to control the CVP and the control valve and a working fluid temperature sensor, wherein the controller commands a change in the CVP ratio based on the working fluid temperature.

### RELATED APPLICATION

The present application claims the benefit of U.S. Provisional Application No. 62/531,076 filed on Jul. 11, 2017, which is incorporated herein by reference in its entirety,

### BACKGROUND

Continuously variable transmissions (CVT) and transmissions that are substantially continuously variable are increasingly gaining, acceptance in various applications. The process of controlling the ratio provided by the CVT is complicated by the continuously variable or minute gradations in ratio presented by the CVT. Furthermore, the range of ratios that are available to be implemented in a CVT are not sufficient for some applications. A transmission is capable of implementing a combination of a CVT with one or more additional CVT stages, one or more fixed ratio range splitters, or some combination thereof in order to extend the range of available ratios. The combination of a CVT with one or more additional stages further complicates the ratio control process, as the transmission will have multiple configurations that achieve the same final drive ratio.

Different transmission configurations multiply input torque across the different transmission stages in different manners to achieve the same final drive ratio. However, some configurations provide more flexibility or better efficiency than other configurations providing the same final drive ratio.

### SUMMARY

Provided herein is a vehicle including: an engine; a continuously variable planetary (CVP) operably coupled to the engine; a cooling system in fluid communication with the engine and the CVP, the cooling system comprising a control valve and a working fluid; and a control system including a controller configured to control the CVP and the control valve and a working fluid temperature sensor, wherein the controller commands a change in the CVP ratio based on the working fluid temperature,

In some embodiments, the controller commands the CVP ratio towards full overdrive when the working fluid temperature is below an extreme cold temperature threshold.

In some embodiments, the controller commands the CVP ratio towards full overdrive when the working fluid temperature is below a cold start temperature threshold.

In some embodiments, the controller is configured to determine the CVP ratio based on an estimate of engine emissions.

In some embodiments, the controller commands the CVP ratio towards full underdrive when the working fluid temperature is below an extreme cold temperature threshold.

In some embodiments, the controller commands the CVP ratio towards full underdrive when the working fluid temperature is below a cold start temperature threshold.

In some embodiments, the working fluid temperature is an engine coolant temperature.

In some embodiments, the working fluid temperature is a CVP fluid temperature.

Provided herein is a method for controlling a vehicle having an engine, a cooling system having a control valve and a working fluid, and a ball-planetary variator (CVP), the method including the steps of: receiving a plurality of data signals provided by sensors located on the vehicle, the plurality of data signals including a CVP ratio, a CVP temperature, an engine speed, and a working fluid temperature; detecting, a cold start operating mode for the engine and the CVP; determining a target CVP ratio corresponding to a minimum engine emission; determining a command for the control valve; and commanding the CVP to operate at a target CVP ratio.

In some, embodiments, detecting a cold start operating mode comprises comparing the working fluid temperature to a cold start temperature threshold.

In some embodiments, the method further includes the step of detecting an extreme cold temperature operating mode.

In some embodiments, detecting the extreme cold temperature operating mode comprises comparing the working fluid temperature to an extreme cold temperature threshold.

In some embodiments, the method further includes commanding the CVP ratio to an overdrive ratio.

In some embodiments, the method further includes further comprising commanding the CVP ratio to an underdrive ratio.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of the preferred embodiments are set forth with particularity in the appended claims. A better understanding of the features and advantages of the present embodiments will be obtained by reference to the following detailed description that sets forth illustrative embodiments, in which the principles of the devices are utilized, and the accompanying drawings of which:

FIG. 1 is a side sectional view of a ball-type variator.

FIG. 2 is a plan view of a carrier member that used in the variator of FIG. 1.

FIG. 3 is an illustrative view of different tilt positions of the ball-type variator of FIG. 1.

FIG. 4 is a block diagram of a vehicle control system implementing the variator of FIG. 1.

FIG. 5 is a representative chart of efficiency for the variator of FIG. 1 as a function of normalized input speed and speed ratio.

FIG. 6 is a representative chart of heat recovery opportunity for the variator of FIG. 1 as a function of normalized speed and speed ratio.

FIG. 7 is a schematic block diagram of coolant flow configuration for one embodiment of a powertrain implementing the variator of FIG. 1.

FIG. 8 is a schematic block diagram of another coolant flow configuration for one embodiment of a powertrain implementing the variator of FIG. 1.

FIG. 9 is a flow chart of a heat recovery control process implemented in the vehicle control system of FIG. 4.

FIG. 10 is a chart depicting heat recovery zones during operation of the variator of FIG. 1.

### DETAILED DESCRIPTION OF THE PREFERRED EMBODIMENTS

An electronic controller is described herein that enables electronic control over a variable ratio transmission having a continuously variable ratio portion, such as a Continuously Variable Transmission (CVT), Infinitely Variable Transmission (IVT), or variator. In some embodiments, the electronic controller is configured to receive input signals indicative of parameters associated with an engine coupled to the transmission.

In some embodiments, the parameters include throttle position sensor values, accelerator pedal position sensor values, vehicle speed, gear selector position, user-selectable mode configurations, and the like, or some combination thereof. The electronic controller receives one or more control inputs.

In some embodiments, the electronic controller determines an active range and an active variator mode based on the input signals and control inputs.

In some embodiments, the electronic controller controls a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in U.S. patent application Ser. No. 14/425,842, entitled “3-Mode Front Wheel Drive And Rear Wheel Drive Continuously Variable Planetary Transmission” and, U.S. patent application Ser. No. 15/572,288, entitled “Control Method of Synchronous Shifting of a Multi-Range Transmission Comprising a Continuously Variable Planetary Mechanism”, each assigned to the assignee of the present application and hereby incorporated by reference herein in its entirety. However, the electronic controller is not limited to controlling a particular type of transmission but rather, is optionally configured to control any of several types of variable ratio transmissions.

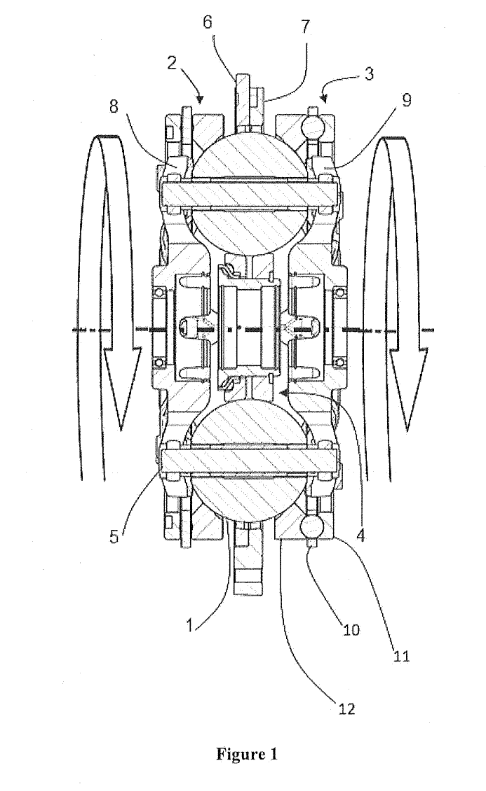

Provided herein are configurations of CVTs based on a ball-type variator, also known as CVP, for continuously variable planetary. Basic concepts of a ball-type Continuously Variable Transmissions are described in U.S. Pat. No. 8,469,856 and 8,870,711 incorporated herein by reference in their entirety. Such a CVT, adapted herein as described throughout this specification, includes a number of balls (planets, spheres) 1, depending on the application, two ring (disc) assemblies with a conical surface contact with the balls, as input (first) traction ring assembly 2 and output (second) traction ring assembly 3, and an idler (sun) assembly 4 as shown on FIG. 1.

In some embodiments, the output traction ring assembly 3 includes an axial force generator mechanism. The balls are mounted on tiltable axles 5, themselves held in a carrier (stator, cage) assembly having a first carrier member 6 operably coupled to a second carrier member 7. The first carrier member 6 rotates with respect to the second carrier member 7, and vice versa.

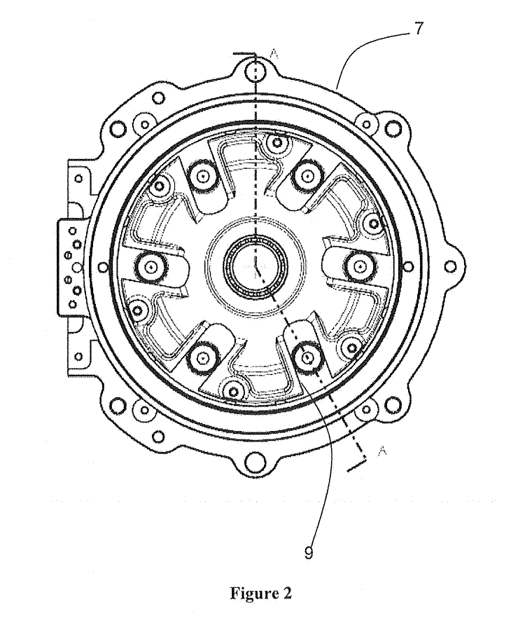

In some embodiments, the first carrier member 6 is substantially fixed, from rotation while the second carrier member 7 is configured to rotate with respect to the first carrier member 6, and vice versa. In one embodiment, the first carrier member 6 is provided with a number of radial guide slots 8. The second carrier member 7 is provided with a number of radially offset guide slots 9, as illustrated in FIG. 2. The radial guide slots 8 and the radially offset guide slots 9 are adapted to guide the tiltable axles 5. The axles 5 are adjustable to achieve a desired ratio of input speed to output speed during operation of the CVT.

In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

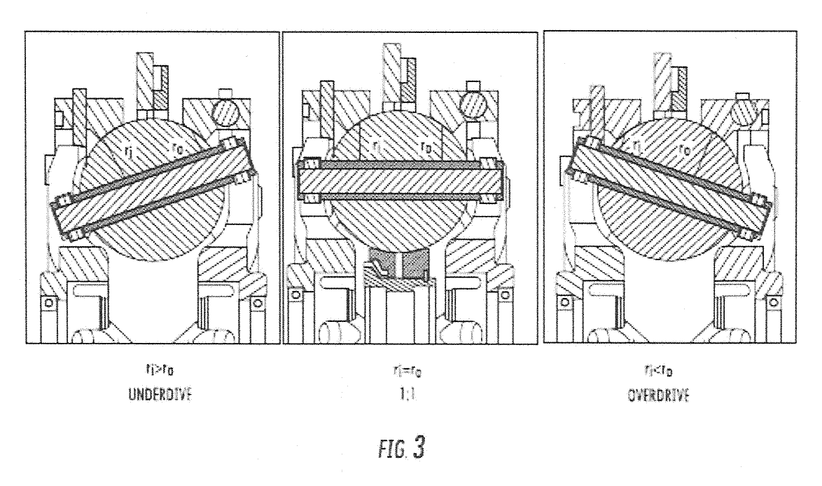

The working principle of such a CVP of FIG. 1 is shown on FIG. 3. The GVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal, the ratio is one, as illustrated in FIG. 3, when the axis is tilted, the distance between the axis and the contact point change, modifying the overall ratio. All the balls' axes are tilted at the same time with a mechanism included in the carrier and/or idler. Embodiments disclosed herein are related to the control of a variator and/or a CVT using generally spherical planets each having a tiltable axis of rotation that is adjustable to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”.

In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected”, “operationally coupled”, “operationally linked”, “operably connected”, “operably coupled”, “operably coupleable”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling will take a variety of forms, which in certain instances will be readily apparent to a person of ordinary skill in the relevant technology.

For description purposes, the term “radial”, as used herein indicates a direction or position that is perpendicular relative to a longitudinal axis, of a transmission or variator. The term “axial” as used herein refers to a direction or position along an axis that is parallel to a main or longitudinal axis of a transmission or variator.

It should be noted that reference herein to “traction” does not exclude applications where the dominant or exclusive mode of power transfer is through “friction”. Without attempting to establish a categorical difference between traction and friction drives herein, generally, these are understood as different regimes of power transfer. Traction drives usually involve the transfer of power between two elements by shear forces in a thin fluid layer trapped between the elements. The fluids used in these applications usually exhibit, traction coefficients greater than conventional mineral oils. The traction coefficient (μ) represents the maximum available traction forces that would be available at the interfaces of the contacting components and is a measure of the maximum available drive torque. Typically, friction drives generally relate to transferring power between two elements by frictional forces between the elements. For the purposes of this disclosure, it should be understood that the CVTs described here could operate in both tractive and frictional applications. As a general matter, the traction coefficient μ is a function of the traction fluid properties, the normal force at the contact area, and the velocity of the traction fluid in the contact area, among other things. For a given traction fluid, the traction coefficient μ increases with increasing relative velocities of components, until the traction coefficient μ reaches a maximum capacity after which the traction coefficient μ decays. The condition of exceeding the maximum capacity of the traction fluid is often referred to as “gross slip condition”. Traction fluid is also influenced by entrainment speed of the fluid and temperature at the contact patch, for example, the traction coefficient is generally highest near zero speed and decays as a weak function of speed. The traction coefficient often improves with increasing temperature until a point at which the traction coefficient rapidly degrades,

As used herein, “creep”, “ratio droop”, or “slip” is the discrete local motion of a body relative to another and is exemplified by the relative velocities of rolling contact components such as the mechanism described herein. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

Those of skill will recognize that the various illustrative logical blocks, modules, circuits, and algorithm steps described in connection with the embodiments disclosed herein, including with reference to the transmission control system described herein, for example, could be implemented as electronic hardware, software stored on a computer readable medium and executable by a processor, or combinations of both. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans could implement the described functionality in varying ways for each particular application, but such implementation decisions should not be interpreted as causing a departure from the scope of the present embodiments.

For example, various illustrative logical blocks, modules, and circuits described in connection with the embodiments disclosed herein could be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor could be a microprocessor, but in the alternative, the processor could be any conventional processor, controller, microcontroller, or state machine. A processor could also be implemented as a combination of computing devices, e.g., a combination of a DSP and a microprocessor, a plurality of microprocessors, one or more microprocessors in conjunction with a DSP core, or any other such configuration. Software associated with such modules could reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such the processor reads information from, and write information to, the storage medium. In the alternative, the storage medium could be integral to the processor. The processor and the storage medium could reside in an ASIC. For example, in one embodiment, a controller for use of control of the CVT includes a processor (not shown).

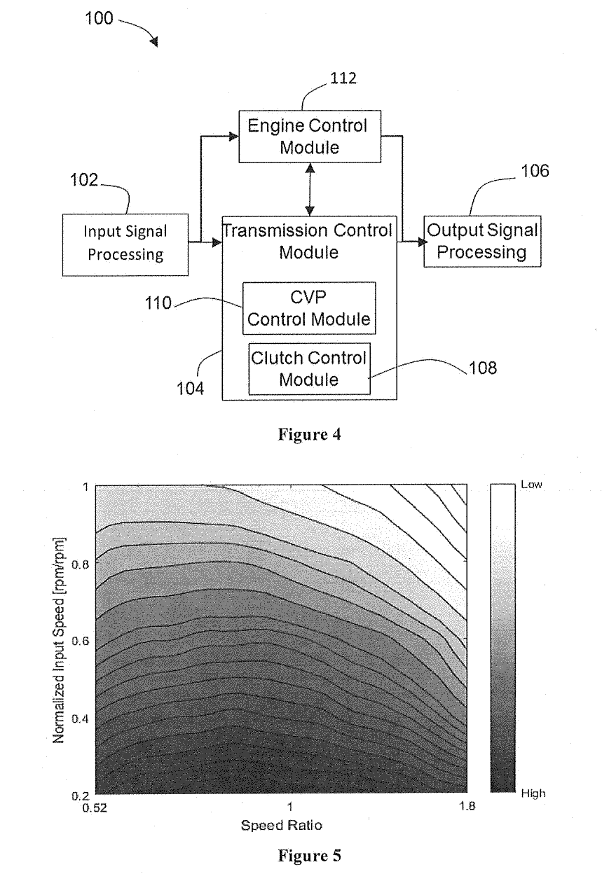

Referring now to FIG. 4, in some embodiments, a vehicle control system 100 includes an input signal processing module 102, a transmission control module 104 and an output signal processing module 106. The input signal processing module 102 is configured to receive a number of electronic signals from sensors provided on the vehicle and/or transmission. The sensors optionally include temperature sensors, speed sensors, position sensors, among others.

In some embodiments, the signal processing module 102 optionally includes various sub-modules to perform routines such as signal acquisition, signal arbitration, or other known methods for signal processing. The output signal processing module 106 is optionally configured to electronically communicate to a variety of actuators and sensors.

In some embodiments, the output signal processing module 106 is configured to transmit commanded signals to actuators based on target values determined in the transmission control module 104. The transmission control module 104 optionally includes a variety of sub-modules or sub-routines for controlling continuously variable transmissions of the type discussed here.

For example, the transmission control module 104 optionally includes a clutch control sub-module 108 that is programmed to execute control over clutches or similar devices within the transmission.

In some embodiments, the clutch control sub-module implements state machine control for the coordination of engagement of clutches or similar devices. The transmission control module 104 optionally includes a CVP control sub-module 110 programmed to execute a variety of measurements and determine target operating conditions of the CVP, for example, of the ball-type continuously variable transmissions discussed here. It should be noted that the CVP control sub-module 110 optionally incorporates a number of sub-modules for performing measurements and control of the CVP.

In some embodiments, the vehicle control system 100 includes an engine control module 112 configured to receive signals from the input signal processing module 102 and in communication with the output signal processing module 106. The engine control module 112 is configured to communicate with the transmission control module 104.

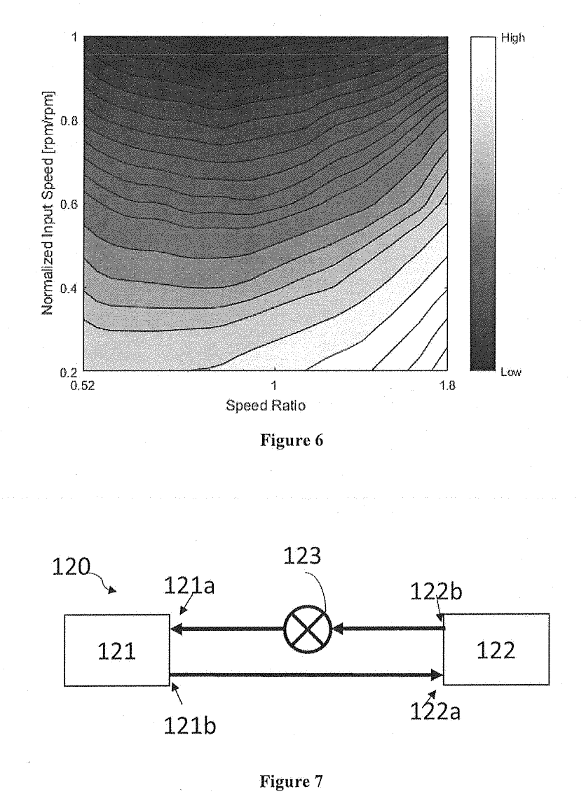

Turning now to FIGS. 5 and 6, cold start engine emissions are a significant contributor to the overall emissions output for vehicles on any given drive cycle. Given that under certain operating conditions the CVP depicted in FIGS. 1-3 exhibits inefficiency, an active control method described herein is implemented to use the inherent waste heat generation of the CVP to positive advantage in reducing engine emissions by assisting the engine and transmission warm up process.

FIG. 5 is a chart depicting CVP efficiency as a function of normalized input speed to the CVP and CVP speed ratio for a given input torque. Considering the downward trajectory of the efficiency curves at the ratio extremes depicted in FIG. 5, the operating conditions at the full overdrive and full underdrive are the areas of heat recovery opportunity. FIG. 6 depicts heat recovery opportunity as a function of normalized input speed to the CVP and CVP speed ratio for a given input torque.

Referring now to FIG. 7, in some embodiments, the vehicle includes a cooling system 120 including a radiator 121 operably coupled to an engine (not shown) and a transmission system 122 having a CVP such as the one depicted in FIGS. 1-3.

In some embodiments, the transmission system 122 is provided with a fluid system configured to circulate a working fluid, such as a traction fluid or transmission fluid, within internal passages of the transmission system 122.

In some embodiments, the radiator 121 is in fluid communication with the transmission system 122.

In some embodiments, the cooling system 120 includes a radiator inlet passage 121a and a radiator outlet or return passage 121b.

In some embodiments, the cooling system 120 includes a transmission inlet passage 122a and a transmission outlet passage 122b.

In some embodiments, the transmission outlet passage 122b is in fluid communication with the radiator inlet passage 121a and the radiator outlet passage 121b is in fluid communication with the transmission inlet passage 122a.

In some embodiments, the cooling system 120 is provided with -a control valve 123 positioned between the radiator inlet passage 121a and a transmission outlet passage 122b.

In some embodiments, during operation of the cooling system 120, the control valve 123 functions as a simple block off valve.

In some embodiments, during operation of the cooling system 120, the control valve 123 functions as a two-way valve to re-route transmission fluid back to the transmission when closed.

In some embodiments, the control valve 123 is a wax pellet thermostat type calibrated to provide the correct operation in each zone.

In some embodiments, the control valve 123 is an electrically actuated valve with full control authority.

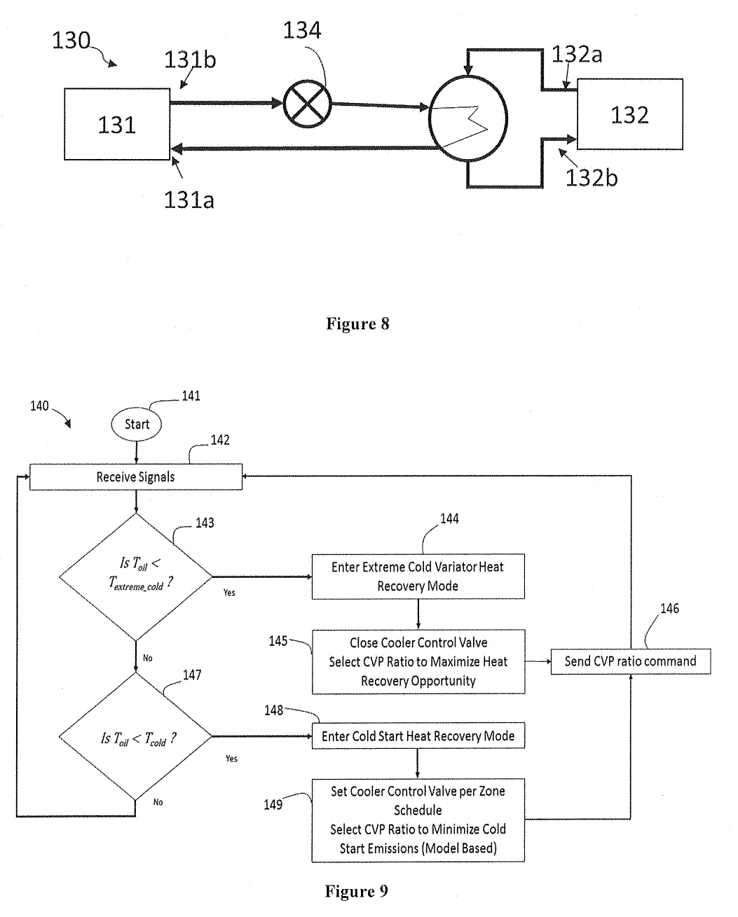

Referring now to FIG. 8, in some embodiments, a cooling system 130 includes an engine 131 and a transmission system 132 having a CVP such as the one depicted in FIGS. 1-3.

In some embodiments, the cooling system 130 includes an engine inlet passage 131a and an engine outlet passage 131b.

In some embodiments, the cooling system 130 includes a transmission inlet passage 132a and a transmission outlet passage 132b.

In some embodiments, the cooling system 130 is provided with a control valve 134 positioned between the engine outlet passage 131b and a heat exchanger 133.

In some embodiments, a heat exchanger 133 is operably coupled to the transmission system 132.

in some embodiments, the transmission system 132 is provided with a fluid system configured to circulate a working fluid, such as a traction fluid or transmission fluid, within internal passages of the transmission system 132. Said fluid system is configured to circulate the working fluid through the heat exchanger 133.

The engine 131 is typically provided with an engine coolant fluid that is circulated through internal passages in the engine 131.

In some embodiments the engine coolant fluid is in fluid communication with the heat exchanger 133 via the passages 131a, 131b.

The heat exchanger 133 transfers heat between the engine coolant fluid leaving the control valve 134 and transmission fluid leaving the transmission 132.

In some embodiments, during operation of the cooling system 130, the control valve 134 operates as a simple block off valve.

In some embodiments, the control valve 134r functions as a two-way valve to re-route transmission fluid back to the engine when closed.

In some embodiments, the control valve is a wax pellet thermostat type calibrated to provide the correct operation in each zone.

In some embodiments, the control valve 134 is an electrically actuated valve with full control authority.

Turning now to FIG. 9, in some embodiments, a heat recovery control, process 140 is implemented in the vehicle control system 100 and is configured to decrease the amount of time for a powertrain equipped with an engine and a CVP to reach normal operating temperatures.

In some embodiments, the heat recovery control process 140 begins at a start state 141 and proceeds to a block 142 where a number of signals are received from other modules within the vehicle control system 100.

In some embodiments, the signals include an ambient temperature, an engine coolant temperature, an engine oil temperature, a CVP fluid temperature, a CVP speed ratio, and a CVP input speed, among other signals.

The heat recovery control process 140 proceeds to a first evaluation block 143 where a fluid temperature such as the engine oil temperature, engine coolant temperature, or the CVP oil temperature, is compared to a calibrateable variable indicative of an extreme cold temperature threshold. When the first evaluation block 143 returns a true result, indicating that the fluid temperature is less than or equal to the predetermined extreme cold temperature threshold, the heat recovery control process 140 proceeds to a block 144 where a command is sent to the CVP control module 110 to enable an extreme cold variator heat recovery mode. The heat recovery control process 140 proceeds to a block 145 where a command is sent to close a control valve, for example the control valve 123 or the control valve 134, and determine a speed ratio of the CVP having a high heat recovery opportunity.

For example, the block 145 evaluates the heat recovery opportunity map depicted in FIG, 6 and selects the CVP speed ratio having the highest heat recovery opportunity that satisfies the driver's demand for operating condition of the vehicle.

The heat recovery control process 140 proceeds to a block 146 where a command is sent to the CVP control module 110 indicating the commanded CVP speed ratio determined in the block 145.

Still referring to FIG. 9, when the first evaluation block 143 returns a false result, indicating that the engine oil temperature is above the extreme cold temperature threshold, the heat recovery control process 140 proceeds to a second evaluation block 147 where the fluid temperature is compared to a second calibrateable variable indicative of a cold start temperature threshold.

In some embodiments, the cold start temperature threshold corresponds to a typical temperate climate temperatures. When the second evaluation block 147 returns a true results indicating that the fluid temperature is less than or equal to the cold start temperature threshold, the heat recovery control process 140 proceeds to a block 148 where a command is sent to the CVP control module 110, for example, to enable a cold start heat recover mode.

The heat recovery control process 140 proceeds to a block 149 where a command is sent to control a control valve, for example, the control valve 123 or the control valve 134. The block 149 is configured to determine a CVP ratio corresponding to an engine operating condition with minimum cold start emissions.

In some embodiments, the engine operating condition for minimum cold start emissions is a model-based algorithm implemented in the vehicle control system 100. The heat recovery control process 140 proceeds to the block 146 where the CVP ratio command is sent to the CVP control module 110.

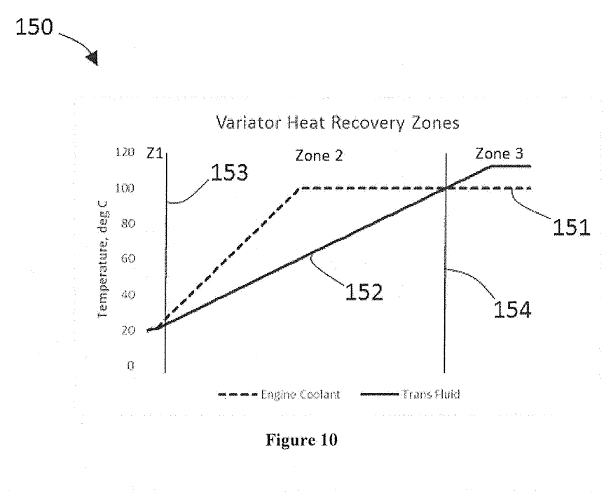

Referring now to FIG. 10, in some embodiments, the heat recovery control process 140 controls the control valve 123 or the control valve 134, for example, at the block 149 according to calibrateable operating zones. A chart 150 depicts an engine coolant temperature 151 and a transmission fluid temperature 152 over time. It should be appreciated, that the engine oil temperature and the CVP oil temperature exhibit similar trends during operation. The engine coolant flow to CVP, or transmission lube flow to heat exchanger during the engine warmup, is controlled using the control valve 123 and the control valve 134, respectively. Given that engine coolant warms faster than engine or transmission oil, the control valve operation is scheduled based on the predetermined operating zones. For example, the following zones of operation are optionally implemented in the block 149 based on evaluation of engine coolant temperature (T_{coolant}) and transmission oil temperature (Tₒᵢₗ):
Zone 1: When T_{coolant}<=Tₒᵢₗ divert coolant away from engine to retain transmission heat
Zone 2: When T_{coolant}>Tₒᵢₗ use engine coolant as pre-heater for transmission fluid
Zone 3: When Tₒᵢₗ>T_{coolant} use engine coolant as needed to cool transmission fluid

In some embodiments, the zone 1 corresponds to the region on the chart 150 where the engine coolant temperature 151 and the transmission fluid temperature 152 are substantially equal and low. Typically zone 1 ends at a first transition time 153. Zone 2 corresponds to the region on the chart 150 where the engine coolant temperature 151 is higher than the transmission fluid temperature 152. Typically zone 2 ends at a transition second transition time 154. Zone 3 corresponds to the region on the chart 150 where the engine coolant temperature 151 is below the transmission fluid temperature 151.

In some embodiments, the control valve may behave differently if the cooling system is in extreme cold situations where rapidly increasing transmission fluid temperature is the dominant goal. In these cases, actively controlling the CVP ratio towards inefficient regions during warmup is implementable in the block 145 of the heat recovery control process 140.

For example, the block 145 is configured to command a CVP ratio change towards an underdrive ratio thereby increasing the input speed, reducing the input torque, and moving operating conditions with lower efficiencies.

In some embodiments, the block 145 is configured to command CVP ratio change towards overdrive ratios thereby decreasing the input speed, increasing input torque, and moving operating conditions towards lower efficiencies. The net effect of inefficient transmission operation for a given drive cycle power requirement is the engine must produce additional output to maintain cycle speed, further enhancing the engine warmup process.

The foregoing description details certain embodiments. It will be appreciated, however, that no matter how detailed the foregoing appears in text, the preferred embodiments are practiced in many ways. As is also stated above, it should be noted that the use of particular terminology when describing certain features or aspects of the preferred embodiments should not be taken to imply that the terminology is being re-defined herein to be restricted to including any specific characteristics of the features or aspects of the preferred embodiments with which that terminology is associated.

While preferred embodiments have been shown and described herein, it will be obvious to those skilled in the art that such embodiments are provided by way of example only. Numerous variations, changes, and substitutions will now occur to those skilled in the art without departing from the preferred embodiments. It should be understood that various alternatives to the preferred embodiments described herein could be employed in practicing the preferred embodiments. It is intended that the following claims define the scope of the preferred embodiments and that methods and structures within the scope of these claims and their equivalents be covered thereby.

What is claimed is:

1. A vehicle comprising:
an engine;
a continuously variable planetary (CVP) operably coupled to the engine;
a cooling system in fluid communication with the engine and the CVP, the cooling system comprising a control valve and a working fluid; and
a control system including a controller configured to control the CVP and the control valve and a working fluid temperature sensor,
wherein the controller commands a change in the CVP ratio based on the working fluid temperature.

2. The vehicle of claim 1, wherein the controller commands the CVP ratio towards full overdrive when the working fluid temperature is below an extreme cold temperature threshold.

3. The vehicle of claim 1, wherein the controller commands the CVP ratio towards full overdrive when the working fluid temperature is below a cold start temperature threshold.

4. The vehicle of claim 1, wherein the controller is configured to determine the CVP ratio based on an estimate of engine emissions.

5. The vehicle of claim 1, wherein the controller commands the CVP ratio towards full underdrive when the working fluid temperature is below an extreme cold temperature threshold.

6. The vehicle of claim 1, wherein the controller commands the CVP ratio towards full underdrive when the working fluid temperature is below a cold start temperature threshold.

7. The vehicle of claim 1, wherein the working fluid temperature is an engine coolant temperature.

8. The vehicle of claim 1, wherein the working fluid temperature is a CVP fluid temperature.

9. A method for controlling a vehicle having an engine, a cooling system having a control valve and a working fluid, and a ball-planetary variator (CVP), the method comprising the steps of:
receiving a plurality of data signals provided by sensors located on the vehicle, the plurality of data signals comprising:
a CVP ratios
a CVP temperature,
an engine speed, and
a working fluid temperature;
detecting a cold start operating mode for the engine and the CVP;
determining a target CVP ratio corresponding to a minimum engine emission;
determining a command for the control valve; and
commanding the CVP to operate at a target CVP ratio.

10. The method of claim 9, wherein detecting a cold start operating mode comprises comparing the working fluid temperature to a cold start temperature threshold.

11. The method of claim 9, further comprising the step of detecting an extreme cold temperature operating mode.

12. The method of claim 11, wherein detecting the extreme cold temperature operating mode comprises comparing the working fluid temperature to an extreme cold temperature threshold.

13. The method claim 9, further comprising commanding the CVP ratio town overdrive ratio.

14. The method of claim 9, further comprising commanding the CVP ratio to an underdrive ratio.
